(19) United States
(12) Patent Application Publication
(10) Pub. No.: US 2013/0199993 A1
(43) Pub. Date: Aug. 8, 2013

(54) FUNCTIONAL CHITOSAN SCAFFOLD WITH SURFACE CHARGE TUNABILITY AS FILTERING MEDIUM

(71) Applicant: NANO AND ADVANCED MATERIALS INSTITUTE LIMITED, Hong Kong (HK)

(72) Inventors: Ka Wai WONG, Hong Kong (HK); Ching Yee Novem LAM, Hong Kong (HK); Mui Kimmy CHAN, Hong Kong (HK)

(73) Assignee: NANO AND ADVANCED MATERIALS INSTITUTE LIMITED, Hong Kong (HK)

(21) Appl. No.: 13/741,368

(22) Filed: Jan. 14, 2013

Related U.S. Application Data
(60) Provisional application No. 61/633,142, filed on Feb. 6, 2012.

(51) Int. Cl. B01D 39/16

(52) U.S. Cl. CPC B01D 39/16
USPC 210/500.1; 536/20; 252/1

(57) ABSTRACT

The present invention discloses a method of preparing a functional chitosan scaffold and said functional chitosan scaffold for use as a filtering medium. Said method involves freeze-drying chitosan in the presence of appropriate cross-linkers and additives. The present chitosan scaffold is associated with an increased mechanical strength and elasticity and an adjustable surface polarity, porosity and morphology which enable its use in a wide range of devices, equipments and appliances in need of a filtering medium such as air or water purification system.

### CROSS REFERENCE TO RELATED APPLICATIONS

The present application claims priority of U.S. provisional application No. 61/633,142 filed on Feb. 6, 2012, the disclosure of which is herein incorporated by reference.

### FIELD OF THE INVENTION

The present invention relates to a highly versatile filtering medium and method of manufacturing the same. Particularly, the present invention relates to the use of and the preparation method of a functional chitosan scaffold for said filtering medium.

### BACKGROUND

Chitosan, a (1-4)-linked 2-amino-2deoxy-D-glucopyranose, is the second-most abundant natural polysaccharide. Chitosan is well known for the superb capacity to adsorb contaminant and heavy metal in water. Chitosan was shown to adsorb 1,000-1,100 g/kg reactive dyes in wastewater which is several times higher than activated carbon commonly used in the filtering industry. Chitosan is also far more superior in terms of bioavailability, biocompatibility and cost as compared to metal-based filters. Nevertheless, despite these advantages of chitosan, it is also associated with various limitations, such as relatively weak mechanical strength and susceptibility to acids and alkalis, preventing it to be used as material alone for air cleaning and water purification applications. Subsequently, research on developing a chitosan that yields practical applications has been widely performed.

Electrospun chitosan nanofibers have recently been developed in the filtering medium industry. A Korean research group developed electrospun chitosan nanofibers mats for adsorption of Cu(II) and Pb(II) in water, while maintaining chitosan's original advantageous properties, such as its biocompatibility, hydrophilicity, bioactivity, non-antigenicity and non-toxicity (Park et al., Journal of Membrane Science, 328, 90, 2009). The excellent metal ion adsorption of electrospun chitosan nanofibers mat found by Park et al., suggests that the potential application of electrospun chitosan to filter out toxic metal ions and microbes. Sun et al. of Sichuan College of Education also reported electrospun chitosan nanofibers having potential applications in other areas such as enzyme immbolization, filtration, wound dressing, tissue engineering and drug delivery (eXPRESS Polymer Letters, Vol. 5, No. 4, 2011, pp 342-361).

Luppi et al. from Bologna University reported a freeze-dried chitosan/pectin for nasal inserts demonstrated improved water uptake ability and mucoadhesion capacity useful in delivering antipsychotic drugs (Luppi et al., European Journal of Pharmaceutics and Biopharmaceutics, Vol 75, Issue 3, 2010, pp 381-387). Other freeze-dried chitosan materials have been reported. For example: Patel et al. teaches a preparation and characterization of freeze-dried chitosan-Poly(ethylene oxide) hydrogels useful for antibiotic delivery in stomach (Patel et al., Pharmaceutical Research, Vol 13, No. 4, 1996, pp 588-593). Nonetheless, none of the existing art discloses a freeze-dried chitosan for use in air or water purification purposes, as freeze-dried chitosan porous material is still found to be too weak in mechanical strength for use as a filtering medium. Moreover, a chitosan scaffold having a tunable surface charge and density has never been reported.

As a result, there is a need to develop a new chitosan material that can be practically applied in purification purposes.

### SUMMARY OF THE INVENTION

The objective of the present invention is to provide a new functional chitosan scaffold for use as a filtering medium and a method of manufacturing said functional chitosan scaffold. Said method of manufacturing involves freeze-drying chitosan with appropriate cross-linkers and additives. The freeze-dried chitosan is further subject to a secondary drying, wherein temperature of the secondary drying is higher than initial freeze-drying temperature to enhance the mechanical strength thereof. The freeze-dried chitosan of the present invention has increased mechanical strength and elasticity as compared to non-freeze-dried chitosan. The appropriate addition of cross-linkers and additives enables porosity and morphology of the chitosan scaffold to be controlled, adjustment of the scaffold's surface polarity and addition of functional properties. In one embodiment, the chitosan of the present invention is freeze-dried with appropriate cross-linkers, additives and titanium dioxide (TiO₂) or other photocatalytic nanoparticles, such that resulting chitosan scaffold is regenerative and re-usable. In another embodiment, the chitosan of the present invention is freeze-dried with appropriate cross-linkers, additives and CaCO₃ to reinforce the hygroscopic and mechanical strength thereof. The superior physical and chemical characteristics of the present chitosan scaffold render it to be an attractive medium for filtration under high pressure and filtering particles or substances of different dimensions and charges.

The present freeze-dried chitosan scaffold filtering medium can filter matter in gaseous or liquid state, such as air and water. The present filtering medium can be incorporated into any apparatuses, equipments or devices in need of a filtering medium, for example, any household appliances, such as air conditioners, water dispensers, etc.

### BRIEF DESCRIPTION OF THE DRAWINGS

FIG. 1 are scanning electron microscope images of freeze-dried chitosan scaffold prepared as described in the present application—FIG. 1a is ×1,000 magnification and FIG. 1b is ×500 magnification.

FIG. 2 are pictures of chitosan scaffolds prepared as described in the present application. FIG. 2a indicates freeze-dried pure chitosan scaffold and FIG. 2b indicates freeze-dried chitosan with CaCO₃.

FIG. 3 shows physical characteristics of the freeze-dried chitosan prepared as described in the present invention. FIG. 3a indicates the chitosan scaffold under no external pressure. The freeze-dried chitosan is shown to be flexible (FIG. 3b) and bendable (FIG. 3c).

### DETAILED DESCRIPTION OF THE INVENTION

Reference is made in detail to the presently preferred embodiment of the present invention, which serve to explain the principles of the invention. The embodiments or examples disclosed herein are described in sufficient detail to enable those skilled in the art to practice the invention, and it is to be understood that other embodiments may be utilized, and that changes may be made without departing from the spirit of the present invention.

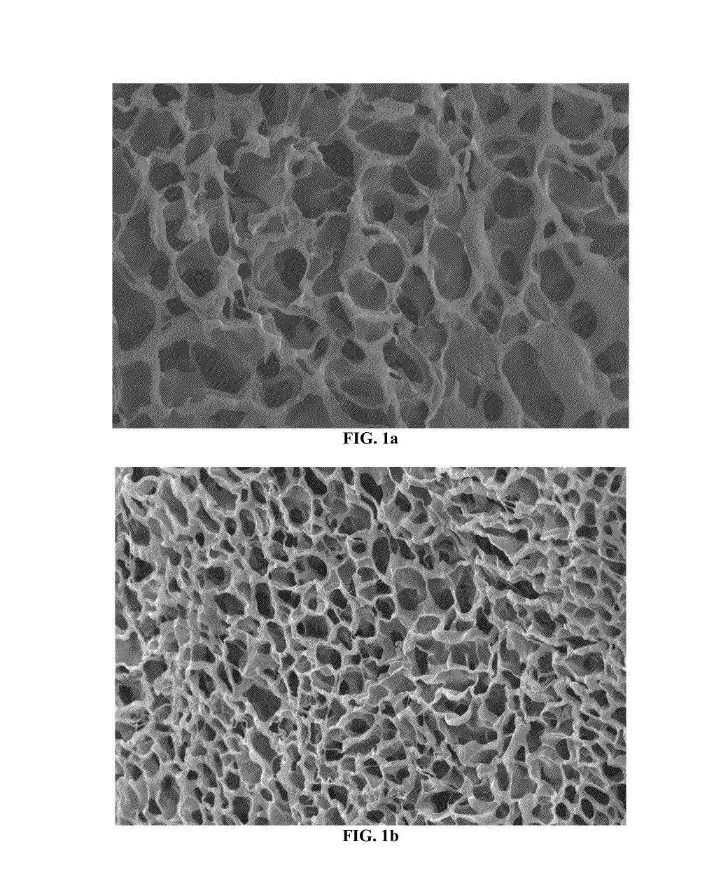

The present invention pertains to a functional chitosan scaffold for a filtering medium and method of manufacturing the same. The method comprises freeze-drying a solution of chitosan. Said freeze-drying comprises freezing said solution of chitosan at a first temperature and a first pressure, and drying said solution under a second temperature and a second pressure to become a first freeze-dried chitosan, and is optionally followed by a second drying of the first freeze-dried chitosan at a third temperature which is higher than the first and second temperatures for mechanical strength reinforcement in the chitosan scaffold. The second drying step aims to reduce any residual moisture in the solution of chitosan and may be carried out under a third pressure that is lower than the first and second pressure. In some embodiments, the freeze-drying step and subsequent second drying step at a higher temperature may be repeated at least once. Said solution of chitosan is prepared by dissolving chitosan in one or more carboxylic acids that act as a solvent and a cross-linker to cross-link the dissolved chitosan molecules. If necessary, dissolution of chitosan may be assisted by homogenization. The nature of said one or more carboxylic acids and the mixing ratio of different carboxylic acids determine the overall surface charge and charge density of the resulting functional chitosan scaffold filtering medium. The chitosan scaffold of the present invention can be positively, negatively charged or neutral. The term “mixing ratio” as used herein refers to the ratios between the one or more carboxylic acids mixed to become a solution for dissolving chitosan. Scanning electron microscope images of chitosan scaffold of the present invention are illustrated in FIGS. 1a and 1b at ×1,000 and ×500 magnifications, respectively.

The present chitosan scaffold can be formed in any dimension and/or shape, either regular or irregular depending on apparatus, device or equipment in which the chitosan scaffold will be used as a filtering medium as a whole, part of a filtering medium or as a stand alone filtering device. This is achieved by transferring the chitosan solution into a container having the desired dimensions and/or shape for the filtering medium or device and conducting the freeze-drying process and subsequent drying therein. Alternatively, the chitosan solution is passed into or through a mold of desired dimensions or shapes or cut into desired dimensions and shape upon freeze-drying process.

The term “chitosan” as used herein, may refer to pure chitosan, a chitosan salt, a chitosan derivative or a combination thereof. Chitosan for use in the present invention may be obtained from natural sources, such as shells of shrimps and crabs by deacetylation of natural chitin in hydrogen peroxide solution or other techniques which are readily known by one skilled in the art. Chitosan may be made synthetically or chemically modified by techniques readily available in the art. In certain embodiments, chitosan suitable for use in the present invention may have a molecular weight in the range of from 5 kDa to 2,000 kDa, or from 50 kDa to 1,000 kDa or from 100 kDa to 900 kDa. Chitosan of a wide range of molecule weights and solubility may be used in the present invention, so long as an appropriate solvent is available to dissolve the chitosan.

In certain embodiments, the chitosan may have a percentage of deacetylation from 40-95% or 75% to 100%. In one embodiment, the chitosan have greater than 95% of deacetylation. In other embodiments, chitosan may be optionally blended with other synthetic polymers and proteins depending upon the desired final application.

To obtain the functional chitosan scaffold useful as a filtering medium of the present invention, one or more of chitosan or derivatives thereof are dissolved in a solution of one or more carboxylic acids. Said solution of one or more carboxylic acids act as a solvent and a cross-linking agent to dissolve and cross-link chitosan ready for freeze-drying. By varying different combinations of carboxylic acids and/or the mixing ratio of different carboxylic acids as readily appreciated by one skilled in the art, solution of negatively, positively or neutral charged chitosan can be obtained. In one embodiment, chitosan are dissolved in >1% acetic acid solution and result in a positively charged surface through protonation of the amine groups. Any acid which serves to protonate amine groups on chitosan may be used in the present invention. Chitosan may be dissolved in, but is not limited to, citric acid, maleic acid, malonic acid, polymannuronic acid, polygalacturonic acid, and succinic acid. In another embodiment, the chitosan may be dissolved dicarboxylic acid, such as oxalic acid, malonic acid, adipic acid, azelaic acid. Other carboxylic acids may be used as the cross-linking agent, provided that the acid is miscible with the chitosan solution. Optionally, chitosan-carboxylic acid solution may further subject to homogenization for a more complete dissolution. Preparation of the functional chitosan scaffold as described herein permits surface charge and charge density of the chitosan scaffold to be tunable, and the functional chitosan scaffold of the present invention has never been reported in any of the existing art.

Upon a more complete dissolution of chitosan after the homogenization, the chitosan-carboxylic solution is then transferred to a suitable container for freeze-drying. The freeze-drying process is simple and conventional as readily known by one skilled in the art and may be performed in a conventional freeze-drying machine. The freeze-drying process includes a first freezing of the chitosan solution at a first temperature ranging from 0° C. to −60° C. and a first pressure of approximately 1000 mtorr for 2-6 hours and then subject the frozen chitosan solution to a second pressure of approximately 0.1 mtorr and a second temperature of approximately 0° C. for a first drying such that the frozen carboxylic acids solvent in the chitosan directly sublime from solid phase into gas phase thereof. The second temperature is higher than the first temperature and the second pressure is lower than the first pressure. In some embodiments, The freeze-drying process further comprises a second drying step that subjects the sublimed chitosan to a third temperature, which is higher than the first and second temperatures, of approximately 0° C. to 40° C. and optionally at a third pressure that is lower than said second pressure to enhance mechanical strength of the resulting functional chitosan scaffold suitable for filtering. The third pressure is in the range of approximately 0.1-0.01 mtorr. In some embodiment, the freeze-drying step and second drying step at a higher temperature may be repeated one or more times. In another embodiment, the present method of manufacturing a functional chitosan scaffold is carried out in a vaccum.

Owing to the freeze-drying technique in the preparation of a functional chitosan scaffold of the present invention and chitosan's intrinsic high chemical versatility, supplementary functional characteristics can be easily added to the chitosan scaffold. In another embodiment, the preparation of a functional chitosan scaffold further comprises adding one or more additives to the chitosan solution prior to the freeze-drying process. Accordingly to the present invention, the additives are added during preparation of the chitosan solution in order to achieve a thorough distribution of additives in the final chitosan scaffold.

In conventional water filters, disposal and replacement of filtering medium are regularly needed, as contaminants saturate within the filtering medium over time. Long term usage of the same filter medium becomes impossible. In one other embodiment, the present invention includes integrating photocatalytic nanoparticles with the functional chitosan scaffold, such that it is possible to regenerate the functional chitosan scaffold through UV-induced photocatalytic decomposition of contaminants. In one embodiment, photocatalytic nanoparticles, such as titanium dioxide (TiO₂) are added to the chitosan solution prior to freeze-drying process. In another embodiment, the chitosan scaffold is capped with cadmium sulfide (CdS). Tin dioxide (SnO₂) and Zinc Oxide (ZnO) can also be immobilized on chitosan scaffold. In particular, it is found that 0.7 g/L CdS or SnO₂/ZnO demonstrated optimal photocatalytic effect. In yet another embodiment, the photocatalytic nanoparticle is cuprous oxide (Cu₂O). Jiang, R et al. Chem. Eng. J. 2009, 152, 537; Zhu, H. Y. et al. Chem. Eng. J. 2011, 172, 746; and Chen, J. Y. et al. Carbohydr. Polym. 2008, 72, 128 describe examples various photocatalytic nanoparticles suitable for incorporation into the subject invention, disclosures thereof are incorporated herein by reference in their entirety.

The present freeze-dried chitosan scaffold is associated with increased mechanical strength and elasticity as compared to those chitosan scaffold prepared using non-freeze-drying technique. In one embodiment, the chitosan is crosslinked with sodium triphosphate pentabasic (TPP) prior to freezing-drying according to the present invention. The mechanical strength and water resistance of the resulting chitosan scaffold was tested by immersing in deionised water for 7 days in which the immersing medium was replaced every day during the experiment. The tested chitosan scaffold crosslinked with TTP prepared according to the present invention retained the shape and spongy structure as those did not subject to immersion.

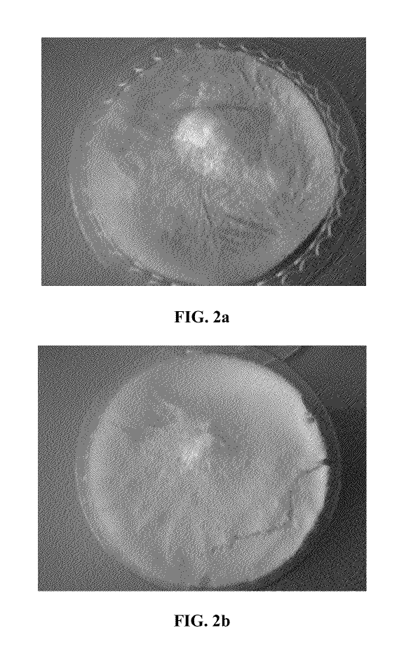

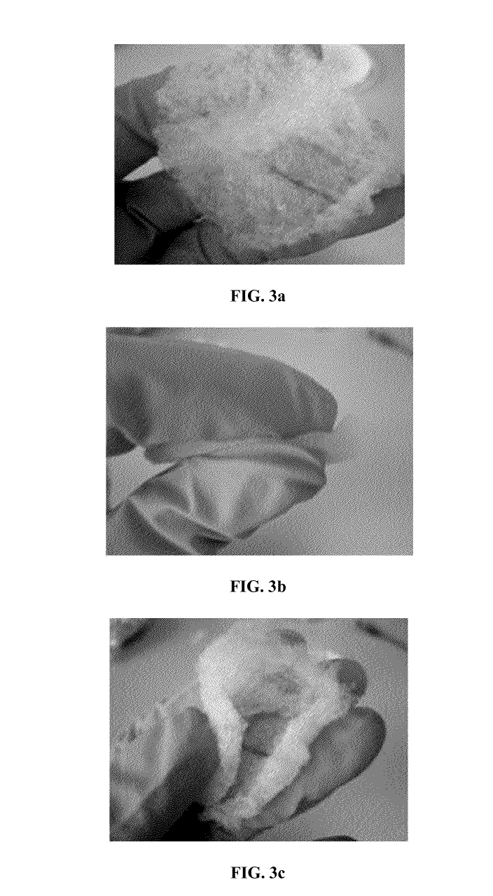

The flexibility of the present chitosan scaffold is demonstrated in FIG. 3b and FIG. 3c. Due to the relatively high mechanical strength, the present chitosan scaffold is able to withstand a relatively high pressure and therefore is excellent for use in water filtration. In another embodiment, the present invention includes freeze-drying chitosan solution with calcium carbonate (CaCO₃) and/or adding CaCO₃ after freeze-drying. FIG. 2 illustrates the appearances of chitosan scaffold prepared according to the present invention; FIG. 2a shows freeze-dried chitosan scaffold without any additives, whereas FIG. 2b shows freeze-dried chitosan-CaCO₃ scaffold. The incorporation of CaCO₃ into chitosan further enhances hygroscopicity and mechanical strength thereof.

A filtering medium made of or comprising the functional chitosan scaffold of the present invention is extremely useful in air and water purification. In particularly, the present chitosan scaffold is effective in absorbing various toxic heavy metal ions commonly found in water, such as ions of copper, lead, arsenic, iron and aluminum.

The present functional chitosan scaffold prepared as described herein is porous, as seen in FIG. 1. The ratio of chitosan to carboxylic acid solvent is adjustable to obtain a scaffold with desired porosity according to the size of particulate, matter, contaminants or the like that intend to be filtered out. The chitosan scaffold is also highly versatile as functional characteristics can be added conveniently to the scaffold by incorporation of additives, such as TiO₂ and CaCO₃.

The competency of the functional chitosan scaffold to vary the surface polarity thereof by freeze-drying chitosan in different carboxylic acid solvents of different mixing ratios enable the scaffold to effectively filter out specific charged chemicals, impurities, any undesirable metal ions or the like. Many microorganisms are charge-sensitive. The polar nature of the chitosan scaffold also increases chitosan's intrinsic antibacterial and antiviral effects. It is appreciated that present method of manufacturing a functional chitosan scaffold can be readily modified by one skilled in the art to tailor make a chitosan scaffold of specific characteristics as a filtering medium for specific filtering purposes.

### INDUSTRIAL APPLICABILITY

The present invention discloses novel method of preparation of chitosan scaffold for the use in filtering purpose. The freeze-drying treatment of chitosan in appropriate carboxylic acid solvents/crosslinkers increases mechanical strength and elasticity of chitosan, permits adjustment of the chitosan's surface polarity and porosity. Furthermore, the freeze-drying treatment of chitosan also provides a convenient channel for incorporation of additives to chitosan such that additional functional characteristics can be added to the scaffold. In view of the foregoing advantages and characteristics associated with the present invention, one skilled in the art would readily knowledge the application of the present chitosan scaffold for use as a filtering medium in a wide range of devices, appliances and equipment in need of a filtering medium.

It is understood that the method described herein may be performed in different order, concurrently and/or together with other steps not mentioned herein but readily appreciated by one skilled in the art to obtain a chitosan scaffold. Without further elaboration, it is believed that one skilled in the art can, based on the description herein, modify the present invention without departing the spirit of the present invention and utilize the present invention to its fullest extend. All publication recited herein are hereby incorporated by reference in their entirety.

What is claimed:

1. A method of preparing a functional chitosan scaffold for a filtering medium comprises
dissolving chitosan or derivatives thereof in a solution of one or more carboxylic acids to form a chitosan solution, wherein said one or more carboxylic acids act as a solvent and a cross-linking agent to dissolve and cross-link said chitosan or derivatives thereof;
freeze-drying said chitosan solution, wherein said freeze-drying comprises freezing said chitosan solution at a first temperature under a first pressure and drying said solution under a second temperature and pressure, said second temperature is higher than said first temperature and said second pressure is lower than said first pressure such that the solution of one or more carboxylic acids directly sublime from solid phase into gas phase, and
wherein surface charge and charge density of the functional chitosan scaffold is selectively adjusted according to a selected ratio of different carboxylic acids in said solution of one or more carboxylic acids such that the resulting surface charge is positive, negative or neutral.

2. The method of claim 1 further comprises drying the chitosan solution at a third temperature and at a third pressure following said freeze-drying, wherein said third temperature is higher than the first and second temperature and said third pressure is lower than said second pressure for mechanical strength reinforcement in said scaffold.

3. The method of claim 2, wherein said freeze-drying or said drying at the third temperature and third pressure is repeated at least once.

4. The method of claim 1, wherein said solution of one or more carboxylic acids comprises acetic acid, citric acid, maleic acid, malonic acid, polymannuronic acid, polygalacturonic acid, succinic acid, oxalic acid, malonic acid, adipic acid or azelaic acid.

5. The method of claim 1 further comprises homogenizing the chitosan solution after said dissolving to prepare a more completely dissolved chitosan solution prior to said freeze-drying.

6. The method of claim 1 further comprises transferring the chitosan solution to a container prior to said freeze-drying, wherein said container is in the same or different shape and dimension of the filtering medium.

7. The method of claim 1 further comprises adding an effective amount of photocatalytic nanopoarticles into the chitosan solution prior to said freeze-drying to enable substances saturated within said chitosan scaffold be decomposed by UV-induced photocatalysis such that the chitosan scaffold for the filtering medium is regenerative and reusable.

8. The method of claim 1 further comprises adding calcium carbonate into the chitosan solution prior to said freeze-drying for adjusting hygroscopicity and mechanical strength of said scaffold.

9. The method of claim 1 further comprises adding sodium triphosphate pentabasic into the chitosan solution prior to said freeze-drying for enhancing water resistance and mechanical strength of said scaffold

10. A filtering medium suitable for filtering matter in a gaseous or a liquid state comprising a functional chitosan scaffold that has been freeze-dried in a solution of one or more carboxylic acids that act as a solvent and a cross-linking agent to dissolve and cross-link chitosan or derivatives thereof into said functional chitosan scaffold, wherein surface charge and charge density of said functional chitosan scaffold is selectively adjusted according to a ratio of different carboxylic acids in said solution of one or more carboxylic acids such that the resulting surface charge is neutral, positive or negative.

11. The filtering medium of claim 10, wherein said solution of one or more carboxylic acids comprises acetic acid, citric acid, maleic acid, malonic acid, polymannuronic acid, polygalacturonic acid, succinic acid, oxalic acid, malonic acid, adipic acid or azelaic acid.

12. The filtering medium of claim 10, wherein said chitosan scaffold further comprises an effective amount of photocatalytic nanoparticles to enable substances saturated within said chitosan scaffold be decomposed by UV-induced photocatalysis such that the filtering medium is regenerative and reusable.

13. The filtering medium of claim 10, wherein said chitosan scaffold further comprises calcium carbonate such that mechanical strength and hygroscopicity of said chitosan scaffold is adjustable.

14. The filtering medium of claim 10 further comprises sodium triphosphate pentabasic for enhancing water resistance and mechanical strength of said scaffold.

15. A filtering medium suitable for filtering matter in a gaseous or a liquid state comprising a functional chitosan scaffold fabricated according to the method of claim 1.

16. The filtering medium of claim 15, wherein the chitosan scaffold undergo further drying at a third temperature and at a third pressure following said freeze-drying, wherein said third temperature is higher than the first and second temperature and said third pressure is lower than said second pressure for mechanical strength reinforcement in said scaffold.

17. The filtering medium of claim 15 further comprises an effective amount of photocatalytic nanopoarticles to decompose substances saturated within the filtering medium by UV-induced photocatalysis such that the filtering medium is regenerative and reusable.

18. The filtering medium of claim 16 further comprises calcium carbonate such that mechanical strength and hygroscopicity of said chitosan scaffold is adjustable.

19. The filtering medium of claim 16 further comprises sodium triphosphate pentabasic for enhancing water resistance and mechanical strength of said scaffold.
